(19) United States
(12) Patent Application Publication
(10) Pub. No.: US 2025/0188329 A1
(43) Pub. Date: Jun. 12, 2025

(54) CURABLE COMPOSITION

(71) Applicant: Panasonic Intellectual Property Management Co., Ltd., Osaka (JP)

(72) Inventors: Takahiro WAKAIKI, Mie (JP); Hiroki SHINOZAKI, Mie (JP)

(21) Appl. No.: 18/842,283

(22) PCT Filed: Feb. 22, 2023
(86) PCT No.: PCT/JP2023/006424

§ 371 Date: Aug. 28, 2024

(30) Foreign Application Priority Data
Mar. 1, 2022 (JP) 2022-031261

(51) Int. Cl. C09J 181/02; C09J 11/02; C09J 11/06

(52) U.S. Cl. CPC C09J 181/02; C09J 11/02; C09J 11/06

(57) ABSTRACT

A curable composition according to the present disclosure contains an ene compound (A) and a thiol compound (B). The thiol compound (B) includes a compound (B1) having a thioether group and having a thiol group equivalent weight equal to or greater than 100.

### TECHNICAL FIELD

The present disclosure generally relates to a curable composition, and more particularly relates to a curable composition containing an ene compound and a thiol compound.

### BACKGROUND ART

Patent Literature 1 discloses a resin composition including a polyfunctional (meth)acrylate resin, a polyfunctional thiol resin, and a calcium carbonate filler with a purity equal to or greater than 99%.

### CITATION LIST

### Patent Literature

Patent Literature 1: WO 2019/151256 A1

### SUMMARY OF INVENTION

The problem to be overcome by the present disclosure is to provide a curable composition which contains an ene compound and a thiol compound and of which a cured product has good adhesiveness and has adhesive strength that does not decrease easily.

A curable composition according to an aspect of the present disclosure contains an ene compound (A) and a thiol compound (B). The thiol compound (B) includes a compound (B1) having a thioether group and having a thiol group equivalent weight equal to or greater than 100.

### DESCRIPTION OF EMBODIMENTS

In various fields such as the field of camera modules where high reliability is required, a cured product of a resin composition for use as an adhesive needs to have high adhesive strength.

The present inventors attempted to find, while developing such a resin composition for use as an adhesive, a means for increasing the durability of the resin composition.

In the course of this development, the present inventors acquired the idea that the durability of the adhesive would be increased by reducing the hydrolysis of the adhesive. Thus, the present inventors carried out extensive research and development to provide a technique for improving the adhesive's resistance to hydrolysis without causing a decrease in the adhesiveness of the adhesive to eventually conceive the concept of the present disclosure.

Note that even though the present inventors conceived the concept of the present disclosure in this manner, this process should not be construed as limiting the aspects, intended use, and other factors of the present disclosure. Rather the scope of the present disclosure should be defined by the configuration of the present disclosure.

Next, an exemplary embodiment of the present disclosure will be described. Note that the exemplary embodiment to be described below is only an exemplary one of various embodiments of the present disclosure and should not be construed as limiting. Rather, the exemplary embodiment may be readily modified in various manners depending on a design choice or any other factor without departing from the scope of the present disclosure.

A curable composition according to this embodiment (hereinafter also referred to as a “composition (X)”) contains an ene compound (A) and a thiol compound (B). The thiol compound (B) includes a compound (B1) having a thioether group and having a thiol group equivalent weight equal to or greater than 100.

According to this embodiment, a cured product of the composition (X) has good adhesiveness and has adhesive strength that does not decrease easily. The reason is probably as follows. Specifically, since the compound (B1) has a thiol group equivalent weight equal to or greater than 100, the proportion by mass of the thiol compound (B) to the composition (X) increases, and therefore, the proportion by mass of the ene compound (A) decreases accordingly. This reduces the amount of decomposable groups such as ester bonds derived from the ene compound (A) in the cured product, thus making the cured product less easily decomposable. Consequently, this reduce the chances of causing a decrease in the adhesive strength of the cured product with time. In addition, if the compound (B1) has a thioether group, the presence of a sulfur atom with a large atomic weight makes the molecular size of the compound (B1) rather small for its molecular weight. That is why even if the compound (B1) has a thiol group equivalent weight equal to or greater than 100, the compound (B1) may still have good reactivity, and therefore, the cured product may have sufficient adhesiveness.

The composition (X) is preferably used as an adhesive and is more preferably used to bond parts of a precision device such as a camera module. Note that when used as an adhesive, the composition (X) may be used to bond anything. That is to say, the use of the composition (X) is not limited to bonding parts of a precision device such as a camera module. Also, when used as an adhesive, the composition (X) may also be used to bond non-resin materials together. Furthermore, the composition (X) does not have to be used as an adhesive but may also be used as a sealant for electronic components.

Next, respective components included in the composition (X) will be described in detail.

The ene compound (A) and the thiol compound (B) are components with reaction curability to cure the composition (X).

The ene compound (A) contains at least one selected from the group consisting of: a compound having at least one of an acryloyl group or a methacryloyl group (hereinafter referred to as an “acrylic compound”); and a compound having a vinyl group (hereinafter referred to as a “vinyl compound”).

The acrylic compound includes at least one selected from the group consisting of, for example, trimethylolpropane triacrylate, 1,6-hexanediol diacrylate, dimethylol-tricyclodecane diacrylate, acryloylmorpholine, tetrahydrofurfuryl acrylate, 4-hydroxybutyl acrylate, tris-(2-acryloxyethyl) isocyanurate, bis-(2-acryloxyethyl) isocyanurate, caprolactone-modified tris-(2-acryloxyethyl) isocyanurate, isocyanuric acid EO-modified diacrylate, and isocyanuric acid EO-modified triacrylate.

The vinyl compound includes at least one selected from the group consisting of, for example, triallyl isocyanurate, allyl glycidyl ether, trimethylolpropane diallyl ether, and pentaerythritol triallyl ether.

The ene compound (A) preferably contains a compound having an isocyanurate skeleton. This would increase the adhesive strength of a cured product of the composition (X) when the composition (X) is used as an adhesive. In that case, the ene compound (A) preferably contains at least one selected from the group consisting of, for example, tris-(2-acryloxyethyl) isocyanurate, bis-(2-acryloxyethyl) isocyanurate, caprolactone-modified tris-(2-acryloxyethyl) isocyanurate, isocyanuric acid EO-modified diacrylate, isocyanuric acid EO-modified triacrylate, and triallyl isocyanurate.

Note that these are not the only compounds that the ene compound (A) may contain and should not be construed as limiting. Rather, the ene compound (A) may contain any of various other compounds having an ethylenic unsaturated bond.

The ene compound (A) may have a molecular weight equal to or greater than 80 and equal to or less than 1000, for example.

The thiol compound (B) includes a compound (B1) having a thioether group and having a thiol group equivalent weight equal to or greater than 100 as described above. The thiol group equivalent weight of the compound (B1) is more preferably equal to or greater than 130, and even more preferably equal to or greater than 170. Meanwhile, the thiol group equivalent weight of the compound (B1) is preferably equal to or less than 250. This reduces the chances of causing a decrease in the reactivity of the compound (B1). The thiol group equivalent weight is more preferably equal to or less than 220 ana even more preferably equal to or less than 200.

The compound (B1) preferably has an isocyanurate skeleton. This allows the isocyanurate skeleton to increase the flexibility of the cured product, thus further increasing the adhesiveness of the cured product.

The compound (B1) preferably has a substituent (Y) in a straight chain form. The substituent (Y) is bonded to the isocyanurate skeleton and has a thiol group at a terminal thereof. In that case, the substituent (Y) may further increase the flexibility of the cured product, thus further increasing the adhesiveness of the cured product. In addition, the presence of the thiol group at a terminal of the substituent (Y) reduces the chances of causing a decrease in the reactivity of the compound (B1). Optionally, a side chain may be bonded to the substituent (Y).

The substituent (Y) having a thiol group at a terminal thereof preferably has no ester bonds. If the substituent (Y) had any ester bond, then the substituent (Y) would cause cleavage due to hydrolysis of the ester bond. On the other hand, if the substituent (Y) has no ester bonds, such hydrolysis is not produced, thus further reducing the chances of causing a decrease with time in the adhesive strength of the cured product.

It is also preferable that the substituent (Y) having a thiol group at a terminal thereof have a thioether group. In that case, the thioether group included in the substituent (Y) would achieve the advantages of this embodiment.

The compound (B1) preferably has, in one molecule, a plurality of such substituents (Y), each having a thiol group at a terminal thereof. This allows the compound (B1) to have an even higher degree of reactivity and also allows the cured product to have even better flexibility. The number of the substituents (Y) is more preferably two and even more preferably three.

In the substituent (Y), the number of atoms between the thiol group and the isocyanurate skeleton is preferably equal to or greater than 3 and equal to or less than 11. Setting the number of those atoms at a number equal to or greater than 4 allows the cured product to have even better flexibility. Setting the number of those atoms at a number equal to or less than 10 allows the compound (B1) to have even better reactivity. The number of those atoms is more preferably equal to or greater than 5 and even more preferably equal to or greater than 6. Meanwhile, the number of those atoms is more preferably equal to or less than 8 and even more preferably equal to or less than 7.

The compound (B1) may include, for example, a compound expressed by the following formula (1):

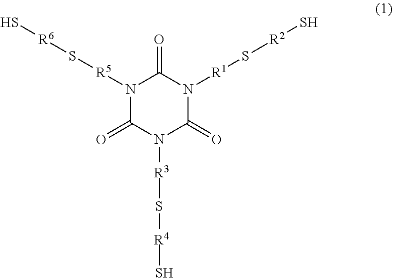

In the formula (1), each of R¹-R⁶ is a divalent saturated hydrocarbon group in a straight chain form, the total number of carbon atoms of R¹ and R² is equal to or greater than 2 and equal to or less than 10, the total number of carbon atoms of R³ and R⁴ is equal to or greater than 2 and equal to or less than 10, and the total number of carbon atoms of R⁵ and R⁶ is equal to or greater than 2 and equal to or less than 10,

The percentage of the compound (B1) to the thiol compound (B) is preferably equal to or greater than 60% by mass and equal to or less than 100% by mass. This allows the advantages of this embodiment to be achieved more fully. The percentage of this compound (B1) is more preferably equal to or greater than 70% by mass and even more preferably equal to or greater than 80% by mass.

The thiol compound (B) may contain only the compound (B1) but may further contain a compound (hereinafter referred to as a “compound (B2)”) other than the compound (B1) as well. If the thiol compound (B) contains the compound (B2), then the compound (B2) preferably includes a compound having at least two thiol groups in one molecule. The thiol compound (B2) more preferably includes a compound having three or more and six or less thiol groups in one molecule.

The thiol compound (B2) contains, for example, an ester of a polyol and a mercapto organic acid. This ester contains at least one of a partial ester or a complete ester.

The polyol includes at least one selected from the group consisting of, for example, ethylene glycol, trimethylolpropane, pentaerythritol, and dipentaerythritol.

The mercapto organic acid includes at least one selected from the group consisting of: a mercapto aliphatic monocarboxylic acid; an ester containing a thiol group and a carboxy group produced by an esterification reaction between a hydroxy acid and a mercapto organic acid; a mercapto aliphatic dicarboxylic acid; and a mercapto aromatic monocarboxylic acid. The mercapto aliphatic monocarboxylic acid includes, for example, at least one selected from the group consisting of, for example: mercaptoacetic acid; a mercaptopropionic acid such as 3-mercaptopropionic acid; and a mercaptobutyric acid such as 3-mercaptobutyric acid and 4-mercaptobutyric acid. The carbon number of the mercapto aliphatic monocarboxylic acid is preferably two to eight, more preferably two to six, even more preferably two to four, and particularly preferably three. The mercapto aliphatic monocarboxylic acid having two to eight carbon atoms includes at least one selected from the group consisting of, for example, mercaptoacetic acid, 3-mercaptopropionic acid, 3-mercaptobutyric acid, and 4-mercaptobutyric acid. The mercapto aliphatic dicarboxylic acid includes at least one selected from the group consisting of, for example, mercaptosuccinic acid and a dimercaptosuccinic acid such as 2,3-dimercaptosuccinic acid. The mercapto aromatic monocarboxylic acid includes a mercaptobenzoic acid such as 4-mercaptobenzoic acid.

The partial ester of the polyol and the mercapto organic acid includes at least one selected from the group consisting of, for example, trimethylolpropane bis(mercaptoacetate), trimethylolpropane bis(3-mercaptopropionate), trimethylolpropane bis(3-mercaptobutyrate), trimethylolpropane bis(4-mercaptobutyrate), pentaerythritol (mercaptoacetate), pentaerythritol tris(3-mercaptopropionate), pentaerythritol tris(3-mercaptobutyrate), pentaerythritol tris (4-mercaptobutyrate), dipentaerythritol tetrakis (mercaptoacetate), dipentaerythritol tetrakis(3-mercaptopropionate), dipentaerythritol tetrakis(3-mercaptobutyrate), and dipentaerythritol tetrakis (4-mercaptobutyrate).

Examples of the complete ester of the polyol and the mercapto organic acid include ethylene glycol bis(mercaptoacetate), ethylene glycol bis (3-mercaptopropionate), ethylene glycol bis(3-mercaptobutyrate), ethylene glycol bis(4-mercaptobutyrate), trimethylol propane tris (mercaptoacetate), trimethylol propane tris(3-mercaptopropionate), trimethylol propane tris(3-mercaptobutyrate), trimethylol propane tris (4-mercaptobutyrate), pentaerythritol tetrakis (mercaptoacetate), pentaerythritol tetrakis(3-mercaptopropionate), pentaerythritol tetrakis(3-mercaptobutyrate), pentaerythritol tetrakis (4-mercaptobutyrate), dipentaerythritol hexakis (mercaptoacetate), dipentaerythritol hexakis (3-mercaptopropionate), dipentaerythritol hexakis (3-mercaptobutyrate), and dipentaerythritol hexakis (4-mercaptobutyrate). The complete ester of the polyol and the mercapto organic acid preferably includes at least one selected from the group consisting of pentaerythritol tetrakis(3-mercaptopropionate), pentaerythritol tetrakis(3-mercaptobutyrate), dipentaerythritol hexakis (3-mercaptopropionate), and trimethylolpropane tris (3-mercaptopropionate).

The thiol compound (B) may contain, for example, tris [(3-mercaptopropionyloxy)-ethyl]-isocyanurate and 1,3,5-tris (3-mercaptobutyloxyethyl)-1,3,5-triazine-2,4,6 (1H, 3H, 5H)-trione.

The thiol compound (B2) may contain any compound other than these. The thiol compound (B2) may contain, for example, at least one selected from the group consisting of, for example, 1,4-butanedithiol, 1,6-hexanedithiol, 1,8-octanedithiol, 1,10-decandithiol, 3,6-dioxa-1,8-octanedithiol, and bis-2-mercaptoethyl sulfide. The thiol compound (B2) may contain at least one selected from the group consisting of, for example, tris (3-mercaptopropyl) isocyanurate, and 1,3,4,6-tetrakis (2-mercaptoethyl) glycoluril.

The thiol compound (B2) may include a compound having a secondary thiol group. The thiol compound (B2) may include at least one selected from the group consisting of, for example, pentaerythritol tetrakis(3-mercaptobutyrate), 1,4-bis(3-mercaptobutyryloxy) butane, 1,3,5-tris (2-(3-sulfanylbutanoyloxy)ethyl)-1,3,5-triazinane-2,4,6-trione, and trimethylolpropane tris(3-mercaptobutyrate). A compound having a secondary thiol group may improve the storage stability of the composition (X) more significantly than a compound having a primary thiol group.

The total percentage of the ene compound (A) and the thiol compound (B) to the solid content of the composition (X) is preferably equal to or greater than 70% by mass. Nevertheless, if the composition (X) contains any filler, the total percentage of the ene compound (A) and the thiol compound (B) is preferably equal to or greater than 70% by mass to the entire solid content of the composition (X) but the filler. This allows the composition (X) to have good reaction curability. This percentage is more preferably equal to or greater than 80% by mass and even more preferably equal to or greater than 90% by mass. Meanwhile, this percentage may be, for example, equal to or less than 97% by mass. As used herein, the “solid content” refers to the component of the composition (X) other than volatile components thereof. The “volatile components” as used herein refer to components that vaporize and do not form part of the cured product while the composition (X) is being cured to form a cured product.

Also, the compounding ratio of the thiol compound (B) to the ene compound (A) is preferably defined such that the thiol compound (B)/ene compound (A) equivalent weight ratio (i.e., the functional group equivalent weight ratio of the thiol compound (B) to the ene compound (A)) is equal to or greater than 0.50 and equal to or less than 1.50. The equivalent weight ratio is more preferably equal to or greater than 0.70 and even more preferably equal to or greater than 0.85. Meanwhile, the equivalent weight ratio is more preferably equal to or less than 1.30 and even more preferably equal to or less than 1.15.

The components having reaction curability in the composition (X) may be only the ene compound (A) and the thiol compound (B). Alternatively, the composition (X) may contain an additional component having reaction curability (hereinafter referred to as a “component (Z)”) other than the ene compound (A) and the thiol compound (B) as long as the advantages of this embodiment are not excessively impaired. If the composition (X) contains the component (Z), the percentage of the component (Z) to the ene compound (A) is preferably greater than 0% by mass and equal to or less than 70% by mass. This percentage is more preferably equal to or less than 50% by mass and even more preferably equal to or less than 30% by mass. Examples of the compounds included in the component (Z) include epoxy compounds, oxetane compounds, phenolic compounds, and amine compounds.

Optionally, the composition (X) may contain a curing catalyst. In that case, the curing catalyst may accelerate the curing reaction of the composition (X).

The curing catalyst may contain an anionic polymerization initiator (C). That is to say, the composition (X) may contain the anionic polymerization initiator (C). This allows the curing reaction of the composition (X) to advance by heating the composition (X).

The anionic polymerization initiator (C) contains at least one component selected from the group consisting of, for example, imidazoles, cycloamidines, tertiary amines, organic phosphines, tetra-substituted phosphonium/tetra-substituted borate, quaternary phosphonium salt having a counter anion other than borate, and tetraphenyl boron salts.

The anionic polymerization initiator (C) may contain a latent curing catalyst (C1). This may suppress the reaction of the composition (X) that is not heated and increase the storage stability of the composition (X). The latent curing catalyst (C1) may contain at least one of a liquid latent curing accelerator or a solid dispersion latent curing accelerator. The latent curing catalyst (C1) may contain a microcapsule latent curing catalyst (C11). The microcapsule latent curing catalyst (C11) includes, as a compound having catalyst activity, a microencapsulated imidazole including an imidazole, for example.

The percentage of the anionic polymerization initiator (C) to the total of the ene compound (A) and the thiol compound (B) is preferably equal to or greater than 0.1% by mass and equal to or less than 35% by mass. Setting the percentage at a value equal to or greater than 0.1% by mass may cause an increase in the reactivity of the composition (X) when the composition (X) is allowed to react and be cured. Setting the percentage at a value equal to or less than 35% by mass may cause a further increase in the storage stability of the composition (X). This percentage is more preferably equal to or greater than 0.3% by mass, even more preferably equal to or greater than 0.5% by mass, and particularly preferably equal to or greater than 0.8% by mass. Also, this percentage is more preferably equal to or less than 20% by mass, even more preferably equal to or less than 15% by mass, and particularly preferably equal to or less than 10% by mass.

The curing catalyst may contain a radical polymerization initiator (D). That is to say, the composition (X) may contain a radical polymerization initiator (D). The radical polymerization initiator (D) may impart photocurability to the composition (X). In particular, if the composition (X) contains the radical polymerization initiator (D) when used as an adhesive, the composition (X) may be cured to a certain degree by irradiating the composition (X) with light. After the composition (X) thus cured has been temporarily bonded, the composition (X) may be heated to be fully cured so that the bonding is done completely. Alternatively, the composition (X) may also be cured even without being heated, and a cured product may be obtained, by irradiating the composition (X) with light to the point that the composition (X) is cured sufficiently.

The radical polymerization initiator (D) includes at least one selected from the group consisting of, for example, aromatic ketones, acylphosphine oxide compounds, aromatic onium salt compounds, organic peroxides, thio compounds (such as thioxanthone compounds and thiophenyl group-containing compounds), hexaaryl biimidazole compounds, ketoxime ester compounds, borate compounds, azinium compounds, metallocene compounds, active ester compounds, compounds each having a carbon-halogen bond, and alkylamine compounds.

The percentage of the radical polymerization initiator (D) to the total of the ene compound (A) and the thiol compound (B) is preferably equal to or greater than 0.05% by mass and equal to or less than 4.0% by mass. This allows sufficient photocurability to be imparted to the composition (X). This percentage is more preferably equal to or greater than 0.1% by mass, even more preferably equal to or greater than 0.2% by mass, and particularly preferably equal to or greater than 0.4% by mass. Also, this proportion is more preferably equal to or less than 3.5% by mass, even more preferably equal to or less than 3.0% by mass, and particularly preferably equal to or less than 2.5% by mass.

The composition (X) may contain a stabilizer (E). As used herein, the stabilizer (E) refers to a compound that inhibits the reaction between the ene compound (A) and the thiol compound (B), which are components with reactivity in the composition (X). Adding the stabilizer (E) to the composition (X) may cause an increase in the storage stability of the composition (X).

The stabilizer (E) preferably contains at least one of a radical polymerization inhibitor or an anionic polymerization inhibitor. This may further increase the storage stability of the composition (X). This is probably because the radical polymerization inhibitor would inhibit the radical polymerization reaction between the ene compound (A) and the thiol compound (B) and the radical polymerization reaction between molecules in the ene compound (A) and the anionic polymerization inhibitor would inhibit the anionic polymerization reaction between the ene compound (A) and the thiol compound (B) while the composition (X) is being stored.

The radical polymerization inhibitor is preferably added to the composition (X) particularly when the composition contains the radical polymerization initiator (D). This may reduce the chances of the curing reaction being advanced in the composition (X) due to the presence of the radical polymerization initiator (D) while the composition (X) is being stored. The radical polymerization inhibitor may contain at least one compound selected from the group consisting of, for example, 4-tert-butylpyrocatechol, tert-butylhydroquinone, 1,4-benzoquinone, dibutyl hydroxytoluene, 1,1-diphenyl-2-picrylhydrazyl free radical, hydroquinone, hydroquinone monomethyl ether, mequinol, phenothiazine, and N-nitroso-N-phenylhydroxylamine aluminum. Note that these are not the only compounds that the radical polymerization inhibitor may contain but should not be construed as limiting.

The anionic polymerization inhibitor is preferably added to the composition (X) particularly when the composition (X) contains the anionic polymerization initiator (C). This may reduce the chances of the curing reaction being advanced in the composition (X) due to the presence of the anionic polymerization initiator (C) while the composition (X) is being stored. The anionic polymerization inhibitor contains, for example, at least one of an organic boric acid compound or a compound having a phenolic hydroxyl group. The organic boric acid compound contains, for example, at least one boric acid ester selected from the group consisting of triethyl borate, tributyl borate, and triisopropyl borate. The compound having a phenolic hydroxyl group contains, for example, at least one selected from the group consisting of 2,3-dihydroxynaphthalene, 4-methoxy-1-naphthol, pyrogallol, methyl hydroquinone, and t-butyl hydroquinone.

The percentage of the stabilizer (E) to the total of the ene compound (A) and the thiol compound (B) is preferably equal to or greater than 0.01% by mass and equal to or less than 1.5% by mass. Setting this percentage at a value equal to or greater than 0.01% by mass may cause a further increase in the storage stability of the composition (X). Setting this percentage at a value equal to or less than 1.5% by mass reduces the chances of the composition (X) losing its curability and enables maintaining high adhesive strength when the composition (X) is cured under an appropriate condition. This percentage is more preferably equal to or greater than 0.05% by mass and even more preferably equal to or greater than 0.10% by mass. Also, this percentage is more preferably equal to or less than 1.0% by mass and even more preferably equal to or less than 0.7% by mass.

The composition (X) may contain a carbodiimide compound (F). This allows the cured product of the composition (X) to have good adhesiveness and reduces the chances of causing a decrease in the adhesive strength of the cured product. The reason is presumably as follows. A carboxy group, produced by the decomposition of an ester bond, derived from the ene compound (A), in the cured product of the composition (X), reacts with the carbodiimide compound (F). This reduces the chances of causing a decrease in the molecular weight of the cured product, thus making the cured product less easily decomposable. Consequently, this reduces the chances of causing a decrease with time in the adhesive strength of the cured product. If the composition (X) contains the carbodiimide compound (F), the percentage of the carbodiimide compound (F) to the total of the ene compound (A) and the thiol compound (B) is preferably equal to or greater than 1% by mass and equal to or less than 20% by mass. Setting this percentage at a value equal to or greater than 1% by mass increases the reliability of the cured product particularly significantly. Meanwhile, setting this percentage at a value equal to or less than 20% by mass allows the composition (X) to maintain a sufficient depth of curing while the composition (X) is being cured. This percentage is more preferably equal to or greater than 3% by mass, even more preferably equal to or greater than 5% by mass, and particularly preferably equal to or greater than 7% by mass. Meanwhile, this percentage is more preferably equal to or less than 15% by mass, even more preferably equal to or less than 12% by mass, and particularly preferably equal to or less than 10% by mass.

The carbodiimide compound (F) is a compound with a carbodiimide group (—N═C═N—) in its molecule. The carbodiimide compound may contain at least one selected from the group consisting of polycarbodiimides, monocarbodiimides, and cyclic carbodiimides. The polycarbodiimide may include at least one of an aliphatic polycarbodiimide or an aromatic polycarbodiimide. The main chain of the aliphatic polycarbodiimide is constituted of aliphatic hydrocarbon. The main chain of the aromatic polycarbodiimide is constituted of aromatic hydrocarbon. The monocarbodiimide may include at least one of an aliphatic monocarbodiimide or an aromatic monocarbodiimide.

The monocarbodiimide includes at least one selected from the group consisting of, for example, N,N′-di-o-toluylcarbodiimide, N,N′-diphenylcarbodiimide, N,N′-di-2,6-dimethylphenyl-carbodiimide, N,N′-bis((2,6-diisopropylphenyl) carbodiimide, N,N′-bis(propylphenyl) carbodiimide, N,N′-dioctyldecylcarbodiimide, N-triyl-N′-cyclohexylcarbodiimide, N,N′-di-2,2-di-tert-butylphenylcarbodiimide, N-triyl-N′-phenylcarbodiimide, N,N′-di-p-nitrophenyl-carbodiimide, N,N′-di-p-aminophenylcarbodiimide, N,N′-di-p-hydroxyphenylcarbodiimide, N,N′-dicyclohexylcarbodiimide, and N,N′-di-p-toluylcarbodiimide.

The polycarbodiimide is a compound expressed by, for example, the following formula:

R²—(—N═C═N—R¹—)ₘ—R³

In this formula, m R¹ each independently indicate either a divalent aromatic group or an aliphatic group. If R¹ is an aromatic group, R¹ may be replaced with at least one of an aliphatic substituent having at least one carbon atom, an alicyclic substituent, or an aromatic substituent. These substituents may have a heteroatom and these substituents may also be substituted for at least one ortho position of the aromatic group to which the carbodiimide group is bonded. R² is an alkyl group having 1 to 18 carbon atoms, a cycloalkyl group having 5 to 18 carbon atoms, an aryl group, an aralkyl group having 7 to 18 carbon atoms, —R⁴—NH—COS—R⁵, —R⁴COOR⁵, —R⁴—OR⁵, —R⁴—N(R⁵)₂, —R⁴—SR⁵, —R⁴—OH, —R⁴—NH₂, —R⁴—NHR⁵, —R⁴-epoxy, —R⁴—NCO, —R⁴—NHCONHR⁵, —R⁴—NHCONR⁵R⁶, or —R⁴—NHCOOR⁷. R³ is —N═C═N-aryl, —N═C═N-alkyl, —N═C═N-cycloalkyl, —N═C═N-aralkyl, —NCO, —NHCONHR⁵, —NHCONHR⁵R⁶, —NHCOOR⁷7, —NHCOS—R⁵, —COOR⁵, —OR⁵, epoxy, —N(R⁵)₂, —SR⁵, —OH, —NH₂, or —NHR⁵. R⁴ is either a divalent aromatic group or aliphatic group. R⁵ and R⁶ each independently indicate an alkyl group having 1 to 20 carbon atoms, a cycloalkyl group having 3 to 20 carbon atoms, an aralkyl group having 7 to 18 carbon atoms, an oligo/polyethylene glycol, or an oligo/polypropylene glycol. R⁷ either includes one of these components of R⁵ or is a polyester group or a polyamide group. m is an integer equal to or greater than 2.

The polycarbodiimide includes at least one selected from the group consisting of, for example, poly (4,4′-dicyclohexylmethane carbodiimide), poly (N,N′-di-2,6-diisopropylphenyl carbodiimide), and poly (1,3,5-triisopropylphenylene-2,4-carbodiimide). Examples of commercially available polycarbodiimides include at least one selected from the group consisting of, for example, an aliphatic polycarbodiimide (ELASTOSTAB H-01 manufactured by Nisshinbo Chemical Inc.) and a carbodiimide-modified isocyanate (CARBODILITE V-05 manufactured by Nisshinbo Chemical Inc.).

The cyclic carbodiimide has, in one molecule, one carbodiimide group and a group (linking group) bonded to both of the two nitrogen atoms (a first nitrogen atom and a second nitrogen atom) of this carbodiimide group. The linking group may be, for example, a divalent group selected from aliphatic groups, alicyclic groups, aromatic groups, and groups consisting of combinations thereof. The linking group may include heteroatoms. The aromatic group may be selected from the group consisting of, for example, an arylene group having 5 to 15 carbon atoms, an arenetriyl groups having 5 to 15 carbon atoms, and an arenetetrayl group having 5 to 15 carbon atoms. The aliphatic group is selected from the group consisting of, for example, an alkylene group having 1 to 20 carbon atoms, an alkanetriyl group having 1 to 20 carbon atoms, and an alkanetetrayl group having 1 to 20 carbon atoms. The alicyclic group is selected from the group consisting of, for example, a cycloalkylene group having 3 to 20 carbon atoms, a cycloalkanetriyl group having 3 to 20 carbon atoms, and a cycloalkanetetrayl group having 3 to 20 carbon atoms.

The carbodiimide compound (F) preferably contains a cyclic carbodiimide. This achieves the advantages of further reducing the chances of causing a decrease in the storage stability of the composition (X) and further increasing the adhesive strength of the cured product.

The composition (X) may contain a filler (G). The filler (G) may reduce the curing shrinkage of the composition (X) while the composition (X) is being cured.

The filler (G) preferably contains a silicone powder (G1). This may further increase the flexibility of the cured product.

The silicone powder (G1) contains at least one selected from the group consisting of, for example, a powder made of silicone rubber (hereinafter referred to as a “silicone rubber powder”), a powder made of a silicone resin (hereinafter referred to as a “silicone resin powder”), and a powder including a core made of silicone rubber and a shell made of a silicone resin (hereinafter referred to as a “silicone composite powder”). As used herein, the “silicone resin” refers to a silicone having a skeleton mainly composed of a three-dimensional siloxane bond, while the “silicone rubber” refers to a silicone having a skeleton mainly composed of a two-dimensional siloxane bond.

The silicone powder (G1) preferably contains at least one of the silicone resin powder or the silicon composite powder. This allows a cured product of the composition (X) to have an even lower elastic modulus in a wide temperature range.

The silicone powder (G1) preferably a mean particle size equal to or greater than 0.3 μm and equal to or less than 30 μm. Setting the mean particle size at a value equal to or greater than 0.3 μm enables achieving the advantage of reducing an excessive increase in the viscosity of the composition (X). Setting the mean particle size at a value equal to or less than 30 μm enables achieving the advantage of maintaining a high degree of infiltration of the composition (X) into a narrow space. This mean particle size is more preferably equal to or greater than 0.5 μm and even more preferably equal to or greater than 0.7 μm. Also, this mean particle size is more preferably equal to or less than 20 μm and even more preferably equal to or less than 10 μm. Note that the mean particle size herein refers to a particle size (d₅₀) having a cumulative frequency of 50% which is calculated based on a volume-based particle size distribution measured by laser diffraction method.

The percentage of the silicone powder (G1) to the composition (X) is preferably equal to or greater than 15% by mass and equal to or less than 50% by mass. Setting this percentage at a value equal to or greater than 15% by mass enables achieving the advantages of increasing the flexibility of the cured product particularly significantly and reducing the curing shrinkage. Setting this percentage at a value equal to or less than 50% by mass enables achieving the advantage of reducing an excessive increase in the viscosity of the composition (X). This percentage is more preferably equal to or greater than 20% by mass, even more preferably equal to or greater than 23% by mass, and particularly preferably equal to or greater than 27% by mass. Also, this percentage is more preferably equal to or less than 45% by mass, even more preferably equal to or less than 40% by mass, and particularly preferably equal to or less than 35% by mass.

It is also preferable that the filler (G) contain an acrylic powder (G2). This may further increase the flexibility of the cured product.

As used herein, the “acrylic powder (G2)” refers to a powder including an acrylic polymer. The acrylic powder (G2) preferably contains a core-shell particle having: a core containing at least one selected from the group consisting of butadiene rubber, butadiene styrene rubber, acrylic rubber, and silicone rubber; and a shell containing an acrylic polymer and coating the core. This may increase the flexibility of the cured product particularly significantly.

Specific examples of the core-shell particle include a powder (MZ-100) consisting of a core made of butadiene styrene rubber and a shell made of an acrylic polymer and a powder (MZ-120) consisting of a core made of butadiene rubber and a shell made of an acrylic polymer.

The acrylic powder (G2) preferably a mean particle size equal to or greater than 100 nm and equal to or less than 500 nm. Setting the mean particle size at a value equal to or greater than 100 nm enables achieving the advantage of reducing an excessive increase in the viscosity of the composition (X). Setting the mean particle size at a value equal to or less than 500 nm enables achieving the advantage of maintaining a high degree of infiltration of the composition (X) into a narrow space. This mean particle size is more preferably equal to or greater than 110 nm and even more preferably equal to or greater than 120 nm. Also, this mean particle size is more preferably equal to or less than 400 nm and even more preferably equal to or less than 300 nm. Note that the mean particle size herein refers to a particle size (d₅₀) having a cumulative frequency of 50% which is calculated based on a volume-based particle size distribution measured by laser diffraction method.

The percentage of the acrylic powder (G2) to the composition (X) is preferably equal to or greater than 5% by mass and equal to or less than 40% by mass. Setting this percentage at a value equal to or greater than 5% by mass enables increasing the flexibility of the cured product particularly significantly and reducing the curing shrinkage. Setting this percentage at a value equal to or less than 40% by mass enables achieving the advantage of reducing an excessive increase in the viscosity of the composition (X). This percentage is more preferably equal to or greater than 10% by mass, even more preferably equal to or greater than 12% by mass, and particularly preferably equal to or greater than 15% by mass. Also, this percentage is more preferably equal to or less than 35% by mass, even more preferably equal to or less than 32% by mass, and particularly preferably equal to or less than 30% by mass.

If the composition (X) contains both the silicone powder (G1) and the acrylic powder (G2), the total percentage of the silicone powder (G1) and the acrylic powder (G2) to the composition (X) is preferably equal to or greater than 5% by mass and equal to or less than 50% by mass. Setting this percentage at a value equal to or greater than 5% by mass enables increasing the flexibility of the cured product particularly significantly and reducing the curing shrinkage. Setting this percentage at a value equal to or less than 50% by mass enables achieving the advantage of reducing an excessive increase in the viscosity of the composition (X). This percentage is more preferably equal to or greater than 10% by mass, even more preferably equal to or greater than 12% by mass, and particularly preferably equal to or greater than 15% by mass. Also, this percentage is more preferably equal to or less than 45% by mass, even more preferably equal to or less than 42% by mass, and particularly preferably equal to or less than 40% by mass.

Optionally, the filler (G) may contain an additional filler (hereinafter referred to as a “filler (G3)”) other than the silicone powder (G1) and the acrylic powder (G2). The filler (G3) may contain an inorganic filler. The filler (G3) may consist of an inorganic filler alone. Adding the inorganic filler to the composition (X) reduces the chances of causing curing shrinkage during the process in which a cured product is formed by causing the composition (X) to be cured. This makes the composition (X) even more suitable for use to bond parts of a precision device such as a camera module. The inorganic filler contains at least one selected from the group consisting of for example, silica, alumina, barium sulfate, talc, clay, mica, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titanate, titanium oxide, barium zirconate, and calcium zirconate. If the filler (G) contains the filler (G3), then the percentage of the filler (G3) to the composition (X) may be, for example, greater than 0% by mass and equal to or less than 30% by mass.

The composition (X) may contain a pigment such as a black pigment, in particular. The black pigment allows the composition (X) and a cured product thereof to be colored in black. Furthermore, in this embodiment, increasing the reactivity of the composition (X) enables, even if the composition (X) is colored in black, maintaining good curability for the composition (X) while the composition (X) is being photocured, for example. The black pigment contains at least one selected from the group consisting of, for example, carbon black and titanium black. If the composition (X) contains a black pigment, the percentage of the black pigment to the composition (X) may be, for example, equal to or greater than 0.01% by mass and equal to or less than 3.0% by mass. This percentage is more preferably equal to or greater than 0.1% by mass, and even more preferably equal to or greater than 0.3% by mass. This percentage is more preferably equal to or less than 2.0% by mass, and even more preferably equal to or less than 1.0% by mass.

The composition (X) may further contain additives other than the components described above as long as the advantages of this embodiment are not impaired excessively. The additive includes at least one selected from the group consisting of, for example, radical scavengers, diluents, solvents, flexibility-imparting agents, coupling agents, antioxidants, thixotropy-imparting agents, and dispersants.

The composition (X) may be prepared by mixing the above-described components of the composition (X).

As described above, the composition (X) may be used as an adhesive. That is to say, a cured product may be formed by curing the composition (X) and may be used to bond two parts that form a device, for example (hereinafter referred to as a “first part” and a “second part,” respectively).

A cured product according to this embodiment is formed by curing the composition (X). As described above, the first part and the second part may be bonded together using this cured product.

A device according to this embodiment includes: a first part; a second part; and a cured product interposed between the first part and the second part to bond the first part and the second part together. The cured product is formed by curing the composition (X). The device may be a precision device such as a camera module as described above. However, this is only an example and should not be construed as limiting. Examples of the device include electronic parts such as semiconductor elements, integrated circuits, large-scale integrated circuits, transistors, thyristors, diodes, and capacitors. If the device is a camera module, bonding the first part and the second part together is, stated otherwise, bonding constituent members of the camera module. Examples of bonding the first and second parts include bonding a board and a camera housing and bonding a lens unit and the camera housing. Note that these are only examples of the first and second parts and should not be construed as limiting.

Examples of respective materials for the first and second parts include, without limitation, resin materials such as a liquid crystal polymer, polycarbonate, polyester, and polyimide, metals such as nickel and copper, ceramics, glass, and various other board materials.

Next, a method for bonding the first and second parts using the composition (X) and a method for manufacturing a device including the first part, the second part, and the cured product will be described.

The composition (X) is interposed between the first part and the second part. In this state, the composition (X) is heated and thereby cured to form a cured product. The first part and the second part are bonded together with this cured product.

If the composition (X) contains a radical polymerization initiator (D), the composition (X) interposed between the first part and the second part is irradiated with light, before being heated, thereby advancing curing of the composition (X) to a certain degree. In this manner, the first part and the second part may be temporarily bonded together. In this case, the wavelength of the light that irradiates the composition (X) is selected appropriately according to the type of the radical polymerizable initiator (D) included in the composition (X). The light may be an ultraviolet ray, for example. Bonding the first part and the second part temporarily in this manner makes it easier to increase the alignment precision by appropriately adjusting the relative positions of the first and second parts.

The condition for heating the composition (X) may be set appropriately to cause the composition (X) to be cured sufficiently. The heating condition includes, for example, a heating temperature equal to or higher than 80° C. and equal to or lower than 120° C. and a heating duration equal to or longer than 30 minutes and equal to or shorter than 120 minutes.

If the composition (X) contains a radical polymerization initiator (D), the composition (X) interposed between the first part and the second part may be irradiated with light, thereby advancing the curing reaction of the composition (X) sufficiently to the point that the composition (X) may be cured even without being heated. In this manner, a cured product may be formed. Even in that case, the first part and the second part are also bonded together with this cured product.

### (Recapitulation)

A curable composition according to a first aspect contains an ene compound (A) and a thiol compound (B). The thiol compound (B) includes a compound (B1) having a thioether group and having a thiol group equivalent weight equal to or greater than 100.

According to this aspect, the curable composition contains an ene compound and a thiol compound and a cured product thereof has good adhesiveness and has adhesive strength that does not decrease easily.

In a second aspect, which may be implemented in conjunction with the first aspect, the compound (B1) has an isocyanurate skeleton.

This aspect may further increase the adhesive strength of a cured product of the curable composition.

In a third aspect, which may be implemented in conjunction with the second aspect, the compound (B1) has a substituent (Y) in a straight chain form. The substituent (Y) is bonded to the isocyanurate skeleton. The substituent (Y) has the thioether group and has a thiol group at a terminal thereof.

This aspect may further increase the adhesive strength of a cured product of the curable composition.

In a fourth aspect, which may be implemented in conjunction with the second or third aspect, the substituent (Y) has no ester bonds.

This aspect may further increase the adhesive strength of a cured product of the curable composition.

In a fifth aspect, which may be implemented in conjunction with any one of the second to fourth aspects, the compound (B1) has a plurality of the substituents (Y).

This aspect allows the compound (B1) to have even higher reactivity and also allows a cured product thereof to have even better flexibility.

In a sixth aspect, which may be implemented in conjunction with any one of the first to fifth aspects, the percentage of the compound (B1) to the thiol compound (B) is equal to or greater than 60% by mass.

In a seventh aspect, which may be implemented in conjunction with any one of the first to sixth aspects, the curable composition further contains a curing catalyst.

This aspect allows the curing catalyst to accelerate the curing reaction of the curable composition.

In an eighth aspect, which may be implemented in conjunction with the seventh aspect, the curing catalyst contains an anionic polymerization initiator (C).

This aspect may advance the curing reaction of the curable composition by heating the curable composition.

In a ninth aspect, which may be implemented in conjunction with the seventh or eighth aspect, the curing catalyst contains a radical polymerization initiator (D).

This aspect allows the radical polymerization initiator (D) to impart photocurability to the curable composition.

In a tenth aspect, which may be implemented in conjunction with any one of the first to ninth aspects, the curable composition further contains a stabilizer (E).

This aspect may increase the storage stability of the curable composition.

In an eleventh aspect, which may be implemented in conjunction with the tenth aspect, the stabilizer (E) contains an anionic polymerization inhibitor.

This aspect may increase the storage stability of the curable composition.

In a twelfth aspect, which may be implemented in conjunction with the tenth or eleventh aspect, the stabilizer (E) contains a radical polymerization inhibitor.

This aspect may increase the storage stability of the curable composition.

In a thirteenth aspect, which may be implemented in conjunction with any one of the first to twelfth aspects, the curable composition further contains a carbodiimide compound (F).

This aspect allows a cured product of the curable composition to have good adhesiveness and reduces the chances of a causing a decrease in the adhesive strength of the cured product.

In a fourteenth aspect, which may be implemented in conjunction with any one of the first to thirteenth aspects, the curable composition further contains a silicone powder (G1).

This aspect may further increase the flexibility of a cured product of the curable composition.

In a fifteenth aspect, which may be implemented in conjunction with any one of the first to fourteenth aspects, the curable composition further contains an acrylic powder (G2).

This aspect may further increase the flexibility of a cured product of the curable composition.

In a sixteenth aspect, which may be implemented in conjunction with the fifteenth aspect, the acrylic powder (G2) contains a core-shell particle having a core and a shell. The core contains at least one selected from the group consisting of butadiene rubber, butadiene styrene rubber, acrylic rubber, and silicone rubber. The shell contains an acrylic polymer and coats the core.

This aspect may further increase the flexibility of a cured product of the curable composition.

In a seventeenth aspect, which may be implemented in conjunction with any one of the first to sixteenth aspects, the curable composition further contains a black pigment.

In an eighteenth aspect, which may be implemented in conjunction with any one of the first to seventeenth aspects, the curable composition is an adhesive.

### EXAMPLES

Next, more specific examples of this embodiment will be presented. Note that the examples to be described below are only examples of this embodiment and should not be construed as limiting.

### 1. Preparation of Composition

A composition was prepared by mixing together the materials shown in Tables 1-3 (to be posted later). Following are the details of the materials shown in Tables 1-3:

### (1) Ene Compounds

Ene Compound #1: isocyanuric acid EO-modified diacrylate and triacrylate, product name Aronix M-313, manufactured by Toagosei Co., Ltd., having a functional group equivalent weight of 151.5; and
Ene Compound #2: polyfunctional polyester acrylate, product name Aronix M-7100, manufactured by Toagosei Co., Ltd., having a functional group equivalent weight of 190.

### (2) Thiol Compounds

Thiol compound #1: thiol compound expressed by the following formula, product name ACTOCURE SS32, manufactured by Kawaguchi Chemical Industry Co., Ltd., having a functional group equivalent weight (thiol group equivalent weight) of 177;

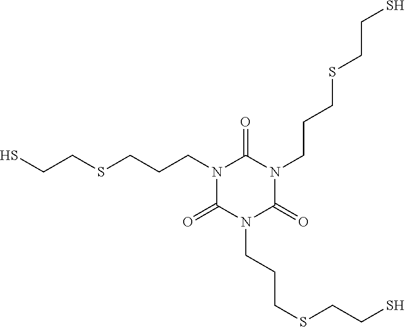 [SMILES: O=c1n(CCCSCCS)c(=O)n(CCCSCCS)c(=O)n1CCCSCCS]

Thiol compound #2: pentaerythritol tetrakis(3-mercaptobutyrate), product name Karenz MTPE1 (R), manufactured by Showa Denko Co., Ltd., having a functional group equivalent weight of 136;
Thiol compound #3:1,3,5-tris (2-(3-sulfanylbutanoyloxy)ethyl)-1,3,5-triazinane-2,4,6-trione expressed by the following formula, product name Karenz MTNR1 (R), manufactured by Showa Denko Co., Ltd., having a functional group equivalent weight (thiol group equivalent weight) of 189;

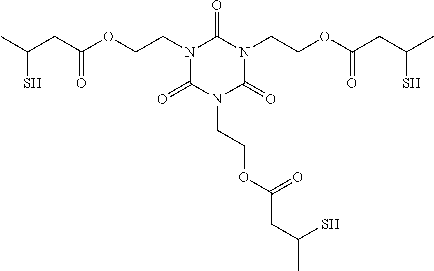 [SMILES: CC(S)CC(=O)OCCn1c(=O)n(CCOC(=O)CC(C)S)c(=O)n(CCOC(=O)CC(C)S)c1=O]

Thiol compound #4: glycoluril derivative expressed by the following formula, product name: TS-G, manufactured by Shikoku Chemicals Corporation, having a functional group equivalent weight (thiol group equivalent weight) of 96;

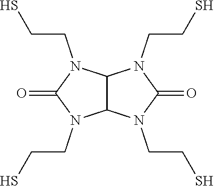 [SMILES: O=C1N(CCS)C2C(N1CCS)N(CCS)C(=O)N2CCS]

Thiol compound #5: glycoluril derivative expressed by the following formula, product name C3TS-G, manufactured by Shikoku Chemicals Corporation, having a functional group equivalent weight (thiol group equivalent weight) of 110; and

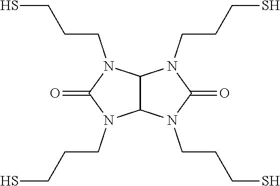 [SMILES: O=C1N(CCCS)C2C(N1CCCS)N(CCCS)C(=O)N2CCCS]

Thiol compound #6: thiol compound expressed by the following formula, product name: Multhiol Y-3, manufactured by Sakai Chemical Industry Co., Ltd., having a functional group equivalent weight (thiol group equivalent weight) of 124.

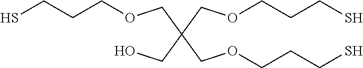 [SMILES: OCC(COCCCS)(COCCCS)COCCCS]

### (3) Anionic Polymerization Initiator

Anionic polymerization initiator: microencapsulated imidazole, product name Novacure HX3722, manufactured by Asahi Kasei E-Materials Co., Ltd.

### (4) Radical Polymerization Initiators

Radical polymerization initiator #1:1-hydroxycyclohexyl-phenyl ketone, product name Omnirad 184, manufactured by IGM Resins B.V.; and
Radical polymerization initiator #2:2: 2,4,6-trimethylbenzoyl-diphenylphosphine oxide, product name Omnirad TPO G, manufactured by IGM Resins B.V.

### (5) Stabilizer

Radical polymerization inhibitor: N-nitroso-N-phenylhydroxylamine aluminum, product name Q-1301, manufactured by FUJIFILM Wako Pure Chemical Corporation; and
Anionic polymerization inhibitor: tributyl borate.

### (6) Fillers

Filler #1: phenyl modified silicone resin powder, product name KMP-708, manufactured by Shin-Etsu Chemical Co., Ltd., having a mean particle size of 2.0 μm;
Filler #2: silicone composite powder, product name KMP-605, manufactured by Shin-Etsu Chemical Co., Ltd., having a mean particle size of 2.0 μm; and
Filler #3: core-shell acrylic powder, product name MZ-120, manufactured by Kaneka Corporation, having a mean particle size of 150 nm.

### (7) Carbodiimide Compound

Carbodiimide compound: powdery cyclic carbodiimide, product name Carbosista TCC-FP20M, manufactured by Teijin Limited.

### (8) Additives

Black pigment: black pigment titanium black, product name TM-B, manufactured by Ako Kasei Co., Ltd.;
Thixotropic agent: thixotropic agent: fumed silica, AEROSIL RY200 manufactured by Nippon Aerosil Co., Ltd.; and
Silane coupling agent: silane coupling agent, Silquest A-187J manufactured by Momentive Performance Materials, Inc.

### 2. Evaluation Tests

### (1) Depth of Curing

A cylindrical cavity having an inside diameter of 3 mm and a depth of 5 mm and having an upper opening was filled with the composition. Using EXECURE-H-1VC manufactured by HOYA Corporation, the composition in the cavity was irradiated with an ultraviolet ray having a peak wavelength of 365 nm at a cumulative illuminance of 4000 mJ/cm².

Subsequently, the composition was unloaded from the cavity, and the surface of a cured portion of the composition was wiped with a sheet of paper to remove an uncured portion from the cured portion. The thickness of this cured portion was measured with a digital caliper. The results are summarized in following Tables 1 and 2.

### (2) Elastic Modulus

A mold release film made of polyethylene terephthalate was placed on a glass plate, and a silicone spacer having an internal space with dimensions of 5 mm×150 mm in plan view and a thickness of 0.5 mm was placed on the mold release film. After the composition had been poured into the internal space of the spacer, another mold release film made of polyethylene terephthalate was placed on the upper surface of the spacer, and a glass plate was placed on the mold release film. The composition was heated to 80° C. for 1 hour to be thermally cured, thereby forming a cured product. The cured product was subjected to a tensile test compliant with the JIS K7127 standard, and the tensile elastic modulus of the cured product was calculated. The results are summarized in the following Tables 1 and 2.

### (3) Elongation

A cured product obtained by the same method as described in the “(2) Elastic modulus” section had its tensile elongation calculated in the same manner as described in the “(2) Elastic modulus” section. The results are summarized in the following Tables 1 and 2.

### (4) Adhesive Strength (Initial)

A test piece (product name: E463i, manufactured by Polyplastics Co., Ltd.) having a smooth surface made of a liquid crystal polymer was provided. This test piece had a surface arithmetic mean roughness Ra (JIS B0601) of 0.47 μm.

A film having a diameter of 5 mm and a thickness of 0.5 mm was formed by applying the composition onto the surface of this adherend. This film was heated to 80° C. for 1 hour to be thermally cured, thereby forming a cured product. Subsequently, using a shear tester (model number DAGE4000 Optima manufactured by Nordson), the shear adhesive strength of the cured product to the test piece was measured under the condition including a test temperature of 25° C., a test speed of 0.1 mm/sec, and a test height of 50 μm. The results are summarized in the following Tables 1-3.

(5) Adhesive Strength (after being Subjected to High-Temperature, High-Humidity Test)

The cured product obtained in the same manner as described in the “(4) Adhesive strength (initial)” section, still stacked on the adherend, was loaded into a high-temperature, high-humidity vessel at 85° C./85% for 500 hours, and then unloaded from the vessel. When 30 to 60 minutes passed since the point in time when the cured product was unloaded from the high-temperature and high-humidity vessel, the shear adhesive strength of the cured product to the adherend was measured in the same manner as described in the “(4) Adhesive strength (initial)” section. The results are summarized in the following Tables 1-3.

TABLE 1

| | | Examples | | | | |
|---|---|---|---|---|---|---|
| | | 1 | 2 | 3 | 4 | 5 |
| Chemical | Ene compound #1 | 39.8 | 39.0 | 38.8 | 35.9 | 39.7 |
| makeup | Ene compound #2 | | | | | |
| (Parts by | Thiol compound #1 | 49.6 | 48.6 | 48.3 | 44.7 | 30.7 |
| Mass) | Thiol compound #2 | | | | | |
| | Thiol compound #3 | | | | | |
| | Thiol compound #4 | | | | | 10.2 |
| | Thiol compound #5 | | | | | |
| | Thiol compound #6 | | | | | |
| | Anionic polymerization initiator | 5.4 | 5.3 | 5.2 | 4.8 | 4.8 |
| | Radical polymerization initiator #1 | | 1.1 | 1.0 | 1.0 | 1.0 |
| | Radical polymerization initiator #2 | | 0.9 | 0.9 | 0.8 | 0.8 |
| | Radical polymerization inhibitor | 0.2 | 0.2 | 0.2 | 0.2 | 0.2 |
| | Anionic polymerization inhibitor | 0.2 | 0.2 | 0.2 | 0.2 | 0.2 |
| | Filler #1 | | | | | |
| | Filler #2 | | | | | |
| | Filler #3 | | | | | |
| | Carbodiimide compound | | | | 7.0 | 7.0 |
| | Black pigment | | | 0.5 | 0.5 | 0.5 |
| | Thixotropic agent | 4.0 | 4.0 | 4.0 | 4.0 | 4.0 |
| | Silane coupling agent | 0.9 | 0.9 | 0.9 | 0.9 | 0.9 |
| | Total | 100.0 | 100.0 | 100.0 | 100.0 | 100.0 |
| Percentage (%) by mass of thiol compound #1 | | 100.0 | 100.0 | 100.0 | 100.0 | 75.0 |
| to entire thiol compound | | | | | | |
| Evaluation | Depth of curing [mm] | — | 1.30 | 0.79 | 0.40 | 0.39 |
| | Elastic modulus [MPa] | 24 | 25 | 21 | 43 | 859 |
| | Elongation [%] | 65 | 62 | 67 | 88 | 60 |
| | Adhesive strength (initial) [MPa] | 4.6 | 4.8 | 4.6 | 6.8 | 10.2 |
| | Adhesive strength (after high-temperature, | 1.4 | 1.5 | 1.3 | 2.6 | 4.6 |
| | high-humidity test) [MPa] | | | | | |

TABLE 2

| | | Examples | | | | |
|---|---|---|---|---|---|---|
| | | 6 | 7 | 8 | 9 | 10 |
| Chemical | Ene compound #1 | 41.7 | 40.3 | 29.8 | 34.2 | 34.2 |
| makeup | Ene compound #2 | | | | | |
| (Parts by | Thiol compound #1 | 23.3 | 24.2 | 37.1 | 24.6 | 24.6 |
| Mass) | Thiol compound #2 | | | | | |
| | Thiol compound #3 | | | | | |
| | Thiol compound #4 | 15.6 | | | 8.2 | 8.2 |
| | Thiol compound #5 | | 16.1 | | | |
| | Thiol compound #6 | | | | | |
| | Anionic polymerization initiator | 4.8 | 4.8 | 4.0 | 4.0 | 4.0 |
| | Radical polymerization initiator #1 | 1.0 | 1.0 | 0.8 | 0.8 | 0.8 |
| | Radical polymerization initiator #2 | 0.8 | 0.8 | 0.7 | 0.7 | 0.7 |
| | Radical polymerization inhibitor | 0.2 | 0.2 | 0.2 | 0.2 | 0.2 |
| | Anionic polymerization inhibitor | 0.2 | 0.2 | 0.2 | 0.2 | 0.2 |
| | Filler #1 | | | 20.0 | | |
| | Filler #2 | | | | 20.0 | |
| | Filler #3 | | | | | 20.0 |
| | Carbodiimide compound | 7.0 | 7.0 | 5.8 | 5.8 | 5.8 |
| | Black pigment | 0.5 | 0.5 | 0.5 | 0.5 | 0.5 |
| | Thixotropic agent | 4.0 | 4.0 | | | |
| | Silane coupling agent | 0.9 | 0.9 | 0.9 | 0.9 | 0.9 |
| | Total | 100.0 | 100.0 | 100.0 | 100.0 | 100.0 |
| Percentage (%) by mass of thiol compound #1 | | 60.0 | 60.0 | 100.0 | 75.0 | 75.0 |
| to entire thiol compound | | | | | | |
| Evaluation | Depth of curing [mm] | 0.42 | 0.43 | 0.42 | 0.37 | 0.44 |
| | Elastic modulus [MPa] | 1622 | 1456 | 1750 | 597 | 486 |
| | Elongation [%] | 24 | 28 | 15 | 45 | 25 |
| | Adhesive strength (initial) [MPa] | 12.3 | 11.8 | 12.5 | 7.2 | 7.2 |
| | Adhesive strength (after high-temperature, | 5.2 | 4.9 | 5.3 | 2.8 | 2.5 |
| | high-humidity test) [MPa] | | | | | |

TABLE 3

| | | Comparative examples | | | | | |
|---|---|---|---|---|---|---|---|
| | | 1 | 2 | 3 | 4 | 5 | 6 |
| Chemical | Ene compound #1 | 44.8 | 37.6 | 52.4 | 48.6 | | |
| makeup | Ene compound #2 | | | | | 53.2 | 49.3 |
| (Parts by | Thiol compound #1 | | | | | | |
| Mass) | Thiol compound #2 | 43.2 | | | | | |
| | Thiol compound #3 | | 50.4 | | | | |
| | Thiol compound #4 | | | 35.5 | | | |
| | Thiol compound #5 | | | | 39.3 | 22.4 | 20.8 |
| | Thiol compound #6 | | | | | 9.6 | 8.9 |
| | Anionic polymerization initiator | 7.9 | 7.9 | 7.9 | 7.9 | 7.7 | 7.1 |
| | Radical polymerization initiator #1 | 0.9 | 0.9 | 0.9 | 0.9 | 0.9 | 0.8 |
| | Radical polymerization initiator #2 | 0.4 | 0.4 | 0.4 | 0.4 | 0.4 | 0.4 |
| | Radical polymerization inhibitor | 0.1 | 0.1 | 0.1 | 0.1 | 0.1 | 0.1 |
| | Anionic polymerization inhibitor | 0.3 | 0.3 | 0.3 | 0.3 | 0.3 | 0.3 |
| | Filler #1 | | | | | | |
| | Filler #2 | | | | | | |
| | Filler #3 | | | | | | |
| | Carbodiimide compound | | | | | | 7.0 |
| | Black pigment | 0.5 | 0.5 | 0.5 | 0.5 | 0.5 | 0.5 |
| | Thixotropic agent | 1.0 | 1.0 | 1.0 | 1.0 | 4.0 | 4.0 |
| | Silane coupling agent | 0.9 | 0.9 | 0.9 | 0.9 | 0.9 | 0.9 |
| | Total | 100.0 | 100.0 | 100.0 | 100.0 | 100.0 | 100.0 |
| Percentage (%) by mass of thiol | | 0.0 | 0.0 | 0.0 | 0.0 | 0.0 | 0.0 |
| compound #1 to entire thiol compound | | | | | | | |
| Evaluation | Depth of curing [mm] | 0.86 | 0.87 | 0.80 | 0.89 | 0.70 | 0.40 |
| | Elastic modulus [MPa] | 423 | 359 | 2335 | 2119 | 16 | 180 |
| | Elongation [%] | 64 | 108 | 4 | 4 | 24 | 18 |
| | Adhesive strength (initial) [MPa] | 10.6 | 11.0 | 5.5 | 5.0 | 2.1 | 4.0 |
| | Adhesive strength (after high- | 0.1 | 0.1 | 0.3 | 0.2 | 0.5 | 1.2 |
| | temperature, high-humidity test) | | | | | | |
| | [MPa] | | | | | | |

1. A curable composition containing:
an ene compound (A); and
a thiol compound (B),
the thiol compound (B) including a compound (B1) having a thioether group, the compound (B1) having a thiol group equivalent weight equal to or greater than 100.

2. The curable composition of claim 1, wherein
the compound (B1) has an isocyanurate skeleton.

3. The curable composition of claim 2, wherein
the compound (B1) has a substituent (Y) in a straight chain form, the substituent (Y) being bonded to the isocyanurate skeleton, and
the substituent (Y) has the thioether group and has a thiol group at a terminal.

4. The curable composition of claim 3, wherein
the substituent (Y) has no ester bonds.

5. The curable composition of claim 3, wherein
the compound (B1) has a plurality of the substituents (Y).

6. The curable composition of claim 1, wherein
percentage of the compound (B1) to the thiol compound (B) is equal to or greater than 60% by mass.

7. The curable composition of claim 1, further containing a curing catalyst.

8. The curable composition of claim 7, wherein
the curing catalyst contains an anionic polymerization initiator (C).

9. The curable composition of claim 7, wherein
the curing catalyst contains a radical polymerization initiator (D).

10. The curable composition of claim 7, further containing a stabilizer (E).

11. The curable composition of claim 8, containing an anionic polymerization inhibitor (E1).

12. The curable composition of claim 9, containing a radical polymerization inhibitor.

13. The curable composition of claim 1, further containing a carbodiimide compound (F).

14. The curable composition of claim 1, further containing a silicone powder (G1).

15. The curable composition of claim 1, further containing an acrylic powder (G2).

16. The curable composition of claim 15, wherein
the acrylic powder (G2) contains a core-shell particle having a core and a shell, the core containing at least one selected from the group consisting of butadiene rubber, butadiene styrene rubber, acrylic rubber, and silicone rubber, the shell containing an acrylic polymer and coating the core.

17. The curable composition of claim 1, further containing a black pigment.

18. The curable composition of claim 1, wherein
the curable composition is an adhesive.
